(19) United States
(12) Patent Application Publication
(10) Pub. No.: US 2025/0341411 A1
(43) Pub. Date: Nov. 6, 2025

(54) TEMPERATURE MEASUREMENT SELF-COMPENSATION METHOD FOR MAGNETIC INDUCTIVE FLOW SENSORS

(71) Applicant: Anderson Instrument Co. LLC, Fultonville, NY (US)

(72) Inventors: Alex KONTSCHEV, Erkheim (DE); Johannes WANNER, Egg an der Guenz (DE)

(21) Appl. No.: 19/187,254

(22) Filed: Apr. 23, 2025

Related U.S. Application Data
(60) Provisional application No. 63/642,560, filed on May 3, 2024.

(51) Int. Cl. G01F 1/58

(52) U.S. Cl. CPC G01F 1/584

(57) ABSTRACT

Systems, apparatuses, and methods provide for a magnetic inductive flow sensor including a housing with an internal passage. A pair of electro-magnets are positioned within the housing on opposite sides of the internal passage to generate a magnetic field when charged. A pair of electrodes are positioned within the housing on opposite sides of the internal passage to detect a voltage representative of a change in the magnetic field as fluid flows through the internal passage. A first temperature sensor is positioned within the housing. The first temperature sensor detects a first value representative of a first temperature of the fluid. The first temperature sensor is composed of a positive temperature coefficient material. A second temperature sensor is positioned within the housing. The second temperature sensor detects a second value representative of a second temperature of the fluid. The second temperature sensor is composed of a negative temperature coefficient material.

### FIELD

The instant disclosure relates generally to systems, apparatuses, and methods for magnetic inductive flow meters. In particular, embodiments of the instant disclosure relate to systems, apparatuses, and methods for self-compensating temperature measurements in such magnetic inductive flow meters to address long-term drift in field conditions.

### BACKGROUND

Magnetic inductive flow meters are widely used for measuring the flow rate of conductive fluids. These devices often incorporate temperature measurement capabilities to enhance accuracy. Existing solutions typically involve the use of a secondary temperature measurement system. However, these systems are prone to long-term drift when deployed in the field, leading to inaccuracies in temperature measurement over time. Current methods to address this drift are limited to calibration on a bench, which is cumbersome and inconvenient for end-users.

Thus, a more reliable and convenient method for compensating temperature drift in magnetic inductive flow meters when used in the field would be a welcome addition in the art.

### SUMMARY

Advantageously, some implementations discussed herein provide for self-compensating temperature measurements in magnetic inductive flow meters, thereby addressing the issue of long-term drift in field conditions. Some implementations utilize multiple temperature sensor elements, strategically placed to enable effective compensation for drift. This approach enhances the reliability and accuracy of temperature measurements, offering significant benefits to users.

As will be described in greater detail below, in some implementations discussed herein, systems, apparatuses, and methods provide for a magnetic inductive flow sensor including a housing with an internal passage. A pair of electro-magnets are positioned within the housing on opposite sides of the internal passage to generate a magnetic field when charged. A pair of electrodes are positioned within the housing on opposite sides of the internal passage to detect a voltage representative of a change in the magnetic field as fluid flows through the internal passage. A first temperature sensor is positioned within the housing. The first temperature sensor detects a first value representative of a first temperature of the fluid. The first temperature sensor is composed of a positive temperature coefficient material. A second temperature sensor is positioned within the housing. The second temperature sensor detects a second value representative of a second temperature of the fluid. The second temperature sensor is composed of a negative temperature coefficient material.

In one example, a method includes generating, via a pair of electro-magnets, a magnetic field within an internal passage in a housing. In such an example, a voltage representative of a change in the magnetic field is detected as fluid flows through the internal passage, via a pair of electrodes. A first value representative of a first temperature of the fluid is detected, via a first temperature sensor, where the first temperature sensor exhibits a positive temperature coefficient. A second value representative of a second temperature of the fluid is detected, via a second temperature sensor, where the second temperature sensor exhibits a negative temperature coefficient.

In another example, a system, includes a secondary sensor coupled to a magnetic inductive flow sensor. The magnetic inductive flow sensor includes a housing with an internal passage. A pair of electro-magnets are positioned within the housing on opposite sides of the internal passage to generate a magnetic field when charged. A pair of electrodes are positioned within the housing on opposite sides of the internal passage to detect a voltage representative of a change in the magnetic field as fluid flows through the internal passage. A first temperature sensor is positioned within the housing. The first temperature sensor detects a first value representative of a first temperature of the fluid. The first temperature sensor is composed of a positive temperature coefficient material. A second temperature sensor is positioned within the housing. The second temperature sensor detects a second value representative of a second temperature of the fluid. The second temperature sensor is composed of a negative temperature coefficient material.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a perspective view of a magnetic inductive flow sensor according to an example of the instant disclosure;

FIG. 2 illustrates a cross sectional view of an electrode and temperature sensor according to an example of the instant disclosure;

FIG. 3 illustrates another cross sectional view of an electrode and temperature sensor according to an example of the instant disclosure;

FIG. 4 illustrates a further cross sectional view of an electrode and temperature sensor according to an example of the instant disclosure;

FIG. 5 is an illustration of a flowchart of an example method for temperature sensing management for a magnetic inductive flow sensor according to an example of the instant disclosure;

FIG. 6 is an illustration of a flowchart of another example method for temperature sensing management for a magnetic inductive flow sensor according to an example of the instant disclosure;

FIG. 7 is a block diagram illustrating a computer program product according to an example of the instant disclosure;

FIG. 8 is a block diagram illustrating an example fluid delivery apparatus according to an example of the instant disclosure; and

FIG. 9 is a block diagram illustrating a hardware apparatus including a semiconductor package according to an example of the instant disclosure.

### DETAILED DESCRIPTION OF THE PRESENT EMBODIMENTS

As will be described in greater detail below, in some implementations discussed herein, multiple temperature sensor elements are integrated within a magnetic inductive flow meter. In one implementation, two distinct temperature sensor elements are employed, each possessing different temperature coefficients. The first sensor element exhibits a positive temperature coefficient (PTC), while the second sensor element exhibits a negative temperature coefficient (NTC). These sensor elements are placed in close proximity to the measurement electrodes of the magnetic inductive flow meter, either in, on, or near the electrodes, ensuring that both elements have a substantially similar exposure to the process temperature.

During the manufacturing process, both temperature sensor elements may undergo calibration at one or more predefined calibration temperatures. This calibration ensures that the sensors are accurately aligned for subsequent field operations. In field applications, one of the temperature sensor elements serves as the primary measurement element, while the other functions to validate and monitor the temperature drift of the system.

An alert is activated when a drift in one of the temperature sensor elements is detected. To address drift in the primary sensor, the measurement value from the secondary sensor element is utilized to self-compensate the temperature measurement in the system by combining the primary and secondary sensor element output together (e.g., via averaging, weighted averaging, or the like). This approach ensures continuous accuracy and reliability of temperature readings, even in the presence of drift.

In alternative implementations, more than two temperature sensor elements may be incorporated, further enhancing the robustness and accuracy of the self-compensation process. The additional sensors can provide redundancy and improved compensation algorithms, adapting to complex field conditions and ensuring consistent performance.

Advantageously, some implementations discussed herein provide a mechanism for compensating temperature drift directly in the field, eliminating the need for bench calibration and enhancing user convenience. The use of multiple sensor elements with opposing temperature coefficients ensures more precise and reliable temperature measurements, minimizing the impact of drift over time. The ability to incorporate additional sensor elements allows for customization and adaptation to various operational environments and requirements. By reducing the need for frequent recalibration, maintenance costs are lowered and the operational lifespan of the flow meter is extended.

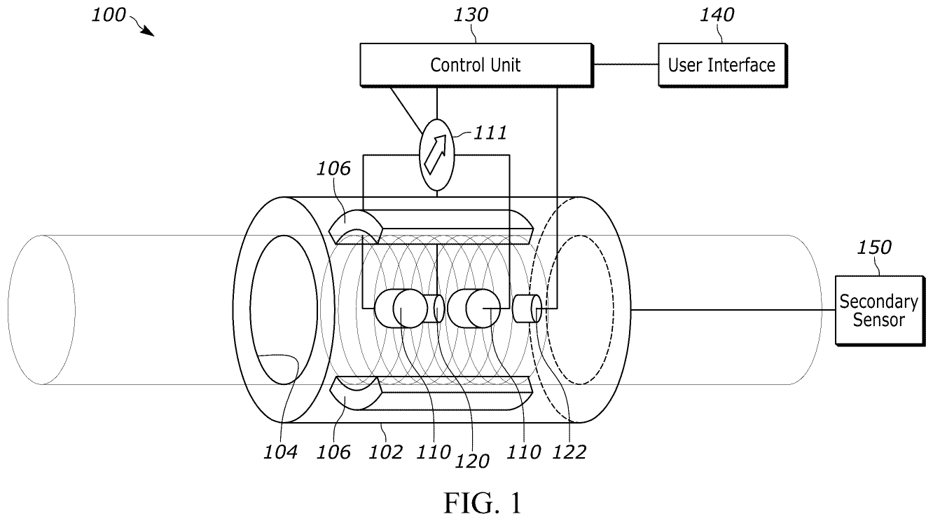

FIG. 1 illustrates a perspective view of a magnetic inductive flow sensor 100 according to an example of the instant disclosure. As illustrated, the magnetic inductive flow sensor 100 includes a housing 102 with an internal passage 104 therein.

A pair of electro-magnets 106 are positioned within the housing 102 on opposite sides of the internal passage 104. The pair of electro-magnets 106 may generate a magnetic field when charged.

A pair of electrodes 110 are positioned within the housing 102 on opposite sides of the internal passage 104. The pair of electrodes 110 may detect a voltage representative of a change in the magnetic field as fluid flows through the internal passage 104.

A first temperature sensor 120 is positioned within the housing 102. In accordance with known techniques, the first temperature sensor 120 may detect a first value representative of a first temperature of the fluid within the internal passage 104. The first temperature sensor is composed of a positive temperature coefficient material.

A second temperature sensor 122 is positioned within the housing 102. The second temperature sensor 122 is illustrated as being positioned opposite to the first temperature sensor 120, however, a different location may be utilized. Also in accordance with known techniques, the second temperature sensor 122 may detect a second value representative of a second temperature of the fluid within the internal passage 104. The second temperature sensor 122 is composed of a negative temperature coefficient material.

Both the first temperature sensor 120 and the second temperature sensor 122 may comprise a resistor. Such a resistor may be a thermistor, for example.

A control unit 130 may be coupled to the pair of electrodes 110 (e.g., via a voltage meter 111), the pair of electro-magnets 106, and/or the first and second temperature sensors. The control unit 130 may generate a magnetic field by controlling current to the electro-magnets 106. Using known techniques, the control unit 130 may determine fluid flow based on the detected voltage from electrodes 110 as fluid interacts with the magnetic field. Additionally, or alternatively, the control unit 130 may compare the first value and the second value to monitor the functioning of the first temperature sensor 120 as compared to the second temperature sensor 122. For example, the control unit 130 may compare a difference between the first value and the second value against a threshold. When the threshold is surpassed, this is an indication that the first temperature sensor 120 has drifted to the point of needing recalibration. Use of pairs of temperature sensors 120/122 having opposite polarity temperature coefficients allows comparisons between measurements from the temperature sensors 122 to determine if either or both temperature sensors are experiencing drift. If both temperature sensors 120/122 had matching polarity temperature coefficients, i.e., both PTC or both NTC, both sensors could drift in a similar manner such that any difference between measurements made by the sensors could remain constant even though drift is occurring. By using opposite temperature coefficients for the temperature sensors 120/122, any drift in either temperature sensor is likely to be reflected in an increased difference in resulting measurements by the sensors, an example of which is described in further detail below.

The control unit 130 is configured to generate an alert when the difference between the first value and the second value exceeds the threshold. For example, such an alert may be sent to a user interface 140 or the like. In some implementations, control unit 130 may include computer readable instructions associated with a processor. In some examples, such computer readable instructions may be implemented via hardware, firmware, software, and/or combinations thereof.

Additional temperature sensors may be provided. For example, one or more additional temperature sensors may be provided. For example, additional temperature sensors composed of a negative temperature coefficient material may be provided. Alternatively, additional pairs of sensors (e.g., one composed of a positive temperature coefficient material and one composed of a negative temperature coefficient material) may be provided. The output of these additional temperature sensors may be compared to the first temperature sensor 120 output individually to see if the threshold is exceeded. Alternatively, the output of these additional temperature sensors may be combined with the output of the second temperature sensor 122 (e.g., via averaging, weighted averaging, and/or the like) and the combined result compared to the first temperature sensor 120 output to see if the threshold is exceeded.

In some implementations, a secondary sensor 150 may be coupled to the magnetic inductive flow sensor 100. For example, the secondary sensor 150 may include a pressure sensor, a conductivity sensor, a fluid level sensor, a pH sensor, a dissolved oxygen sensor, a viscosity sensor, a density sensor, a surface cleanliness sensor, the like, and/or combinations thereof. In some implementations, the secondary sensor 150 and the magnetic inductive flow sensor 100 share usage of the control unit 130 in common. In other implementations, the secondary sensor 150 may have an independent control unit.

In operation, both first temperature sensor 120 and second temperature sensor 122 (and any other additional temperature sensors) are calibrated in the factory to ensure, that maximum measured temperature difference (Dmax) between first temperature sensor 120 and second temperature sensor 122 is not bigger than some specified value within a specified temperature range. Example: an absolute value of a difference D between a first value T1 measured by the first temperature sensor and a second value T2 measured by a second temperature sensor is less than 0.2° C. in the temperature range between −20 . . . 200° C. During product life cycle both T1 and T2 are repeatedly measured continuously or with some predefined frequency, for example, one time per second, or the like. During each measurement, an absolute value of the difference D between T1 and T2 is calculated. If D is less than or equal to Dmax then no temperature sensor drift is identified and the normal operating mode can continue. If D is greater than Dmax, however, then a temperature sensor drift is identified and a warning signal is to be generated.

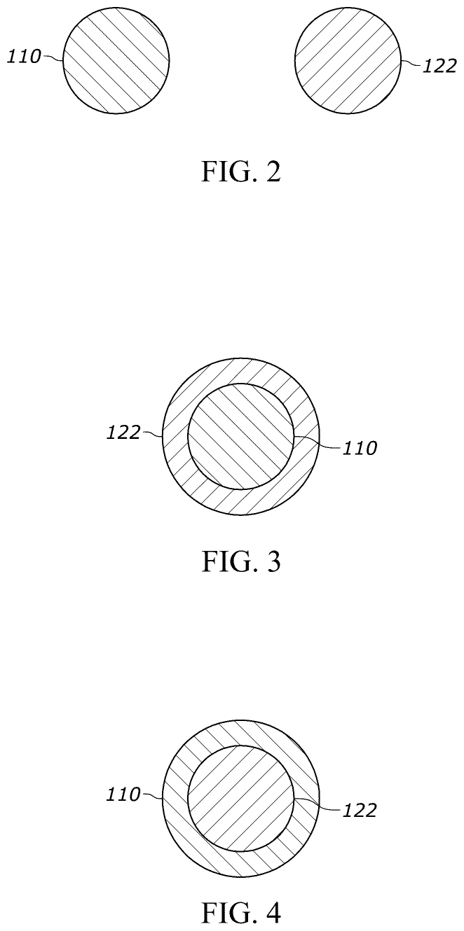

FIG. 2 illustrates a cross sectional view of an electrode and temperature sensor according to an example of the instant disclosure. As illustrated, the second temperature sensor 122 is positioned adjacent one of the electrodes of the pair of electrodes 110. Similarly, the first temperature sensor may be positioned adjacent a different electrode of the pair of electrodes 110.

FIG. 3 illustrates another cross sectional view of an electrode and temperature sensor according to an example of the instant disclosure. As illustrated, the second temperature sensor 122 is positioned on one of the electrodes of the pair of electrodes 110. Similarly, the first temperature sensor may be positioned on a different electrode of the pair of electrodes 110.

FIG. 4 illustrates a further cross sectional view of an electrode and temperature sensor according to an example of the instant disclosure. As illustrated, the second temperature sensor 122 is positioned in one of the electrodes of the pair of electrodes 110. Similarly, the first temperature sensor may be positioned in a different electrode of the pair of electrodes 110.

Alternatively, the first temperature sensor may be positioned in, on, or adjacent the same electrode of the pair of electrodes 110 as the second temperature sensor 122.

As noted above, additional temperature sensors may be provided. For example, additional temperature sensors composed of a negative temperature coefficient material may be provided. Alternatively, additional pairs of sensors (e.g., one composed of a positive temperature coefficient material and one composed of a negative temperature coefficient material) may be provided. Accordingly, these additional sensors may likewise be distributed among the pairs of electrodes 110 in any fashion illustrated in FIGS. 2-4, so as to be positioned in, on, or adjacent the same or different electrode of the pair of electrodes 110 as the second temperature sensor 122.

In implementations where additional temperature sensors may be provided, these additional temperature sensors may likewise be positioned in electrodes 110, on electrodes 110, or adjacent to electrodes 110.

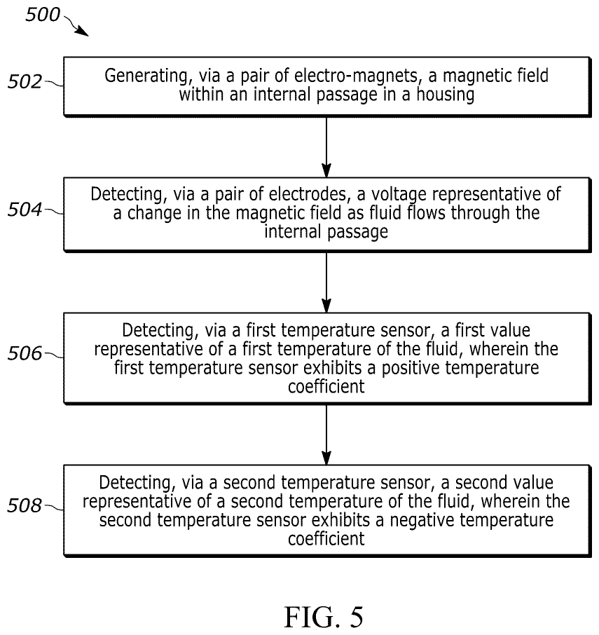

FIG. 5 is a flowchart of an example of a method 500 for temperature sensing management for a magnetic inductive flow sensor according to an example. The method 500 may generally be implemented in an apparatus, such as, for example, the magnetic inductive flow sensor 100 (FIG. 1), already discussed.

In an example, the method 500 can be implemented in computer readable instructions (e.g., software), configurable computer readable instructions (e.g., firmware), fixed-functionality computer readable instructions (e.g., hardware), etc., or any combination thereof.

It will be appreciated that some or all of the operations the method 500 that are described using a “pull” architecture (e.g., polling for new information followed by a corresponding response) can instead be implemented using a “push” architecture (e.g., sending such information when there is new information to report), and vice versa.

Illustrated processing block 502 provides for generating a magnetic field. For example, a magnetic field may be generated within an internal passage in a housing, via a pair of electro-magnets.

Illustrated processing block 504 provides for detecting a voltage. For example, a voltage representative of a change in the magnetic field may be detected as fluid flows through the internal passage, via a pair of electrodes

Illustrated processing block 506 provides for detecting a first value representative of a first temperature of the fluid. For example, a first value representative of a first temperature of the fluid may be detected, via a first temperature sensor, where the first temperature sensor exhibits a positive temperature coefficient.

Illustrated processing block 508 provides for detecting a second value representative of a second temperature of the fluid. For example, a second value representative of a second temperature of the fluid may be detected, via a second temperature sensor, where the second temperature sensor exhibits a negative temperature coefficient.

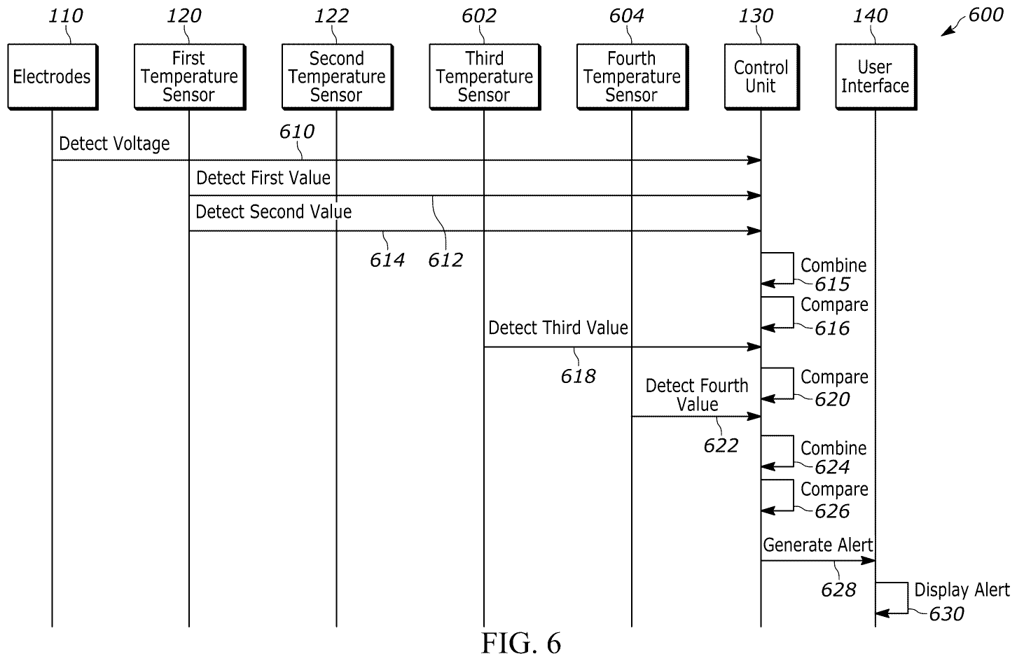

Additional, or alternative details of method 500 are described below with respect to FIG. 6.

FIG. 6 is a flowchart of another example of a method 600 for temperature sensing management for a magnetic inductive flow sensor according to an example. The method 600 may generally be implemented in an apparatus, such as, for example, the magnetic inductive flow sensor 100 (FIG. 1), already discussed.

In an example, the method 600 can be implemented in computer readable instructions (e.g., software), configurable computer readable instructions (e.g., firmware), fixed-functionality computer readable instructions (e.g., hardware), etc., or any combination thereof.

It will be appreciated that some or all of the operations the method 600 that are described using a “pull” architecture (e.g., polling for new information followed by a corresponding response) can instead be implemented using a “push” architecture (e.g., sending such information when there is new information to report), and vice versa.

Illustrated processing block 610 provides for detecting a voltage. For example, a voltage representative of a change in the magnetic field may be detected as fluid flows through the internal passage, via a pair of electrodes

Illustrated processing block 612 provides for detecting a first value representative of a first temperature of the fluid. For example, a first value representative of a first temperature of the fluid may be detected, via a first temperature sensor, where the first temperature sensor exhibits a positive temperature coefficient.

Illustrated processing block 614 provides for detecting a second value representative of a second temperature of the fluid. For example, a second value representative of a second temperature of the fluid may be detected, via a second temperature sensor, where the second temperature sensor exhibits a negative temperature coefficient.

Illustrated processing block 615 provides for combining the first value and the second value. In some implementations, the first value and the second value are combined, so as to be used as the main temperature output of the device. In implementations where more than two temperature sensors are uses, some or all of values from these additional sensors may also be combined. Such combination may be done by averaging, weighted averaging, or the like.

Illustrated processing block 616 provides for comparing the first value and the second value. In some implementations, a difference between the first value and the second value may be compared against a threshold value.

In the case where more than two opposite polarity temperature sensors are provided, options steps 618-626 may be optionally performed. Illustrated processing block 618 provides for detecting a third value representative of a third temperature of the fluid. For example, a third value representative of a third temperature of the fluid may be detected, via a third temperature sensor 602, where the third temperature sensor 602 exhibits a negative temperature coefficient.

Illustrated processing block 620 provides for comparing the first value and the third value. In some implementations, a difference between the first value and the third value may be compared against the threshold value.

As illustrated, additional temperature sensors may be provided. For example, additional temperature sensors composed of a negative temperature coefficient material may be provided. The output of these additional temperature sensors may be compared to the first temperature sensor 120 output individually to see if the threshold is exceeded. Alternatively, the output of these additional temperature sensors may be combined with the output of the second temperature sensor 122 (e.g., via averaging, weighted averaging, and/or the like) and the combined result compared to the first temperature sensor 120 output to see if the threshold is exceeded.

Illustrated processing block 622 provides for detecting a fourth value representative of a first temperature of the fluid. For example, a forth value representative of a fourth temperature of the fluid may be detected, via a fourth temperature sensor 604, where the fourth temperature sensor 604 exhibits a positive temperature coefficient.

Illustrated processing block 624 provides for combining the second value, third value, and fourth value into a combined value. For example, output of these additional temperature sensors may be combined with the output of the second temperature sensor 122 (e.g., via averaging, weighted averaging, and/or the like) and the combined result compared to the first temperature sensor 120 output to see if the threshold is exceeded.

As discussed above, additional temperature sensors may be provided. For example, additional pairs of sensors (e.g., one composed of a positive temperature coefficient material and one composed of a negative temperature coefficient material) may be provided. The output of these additional temperature sensors may be compared to the first temperature sensor 120 output individually to see if the threshold is exceeded. Alternatively, the output of these additional temperature sensors may be combined with the output of the second temperature sensor 122 (e.g., via averaging, weighted averaging, and/or the like) and the combined result compared to the first temperature sensor 120 output to see if the threshold is exceeded.

Illustrated processing block 626 provides for comparing the first value and the combined value. In some implementations, a difference between the first value and the combined value may be compared against the threshold value.

Illustrated processing block 628 provides for generating an alert. For example, an alert may be generated when the threshold is exceeded. For example, the threshold may be exceeded via the comparisons at 616, 620, and/or 626. Such an alert may be sent from the control unit 130 to the user interface 140.

Illustrated processing block 630 provides for displaying the generated alert on the user interface 140.

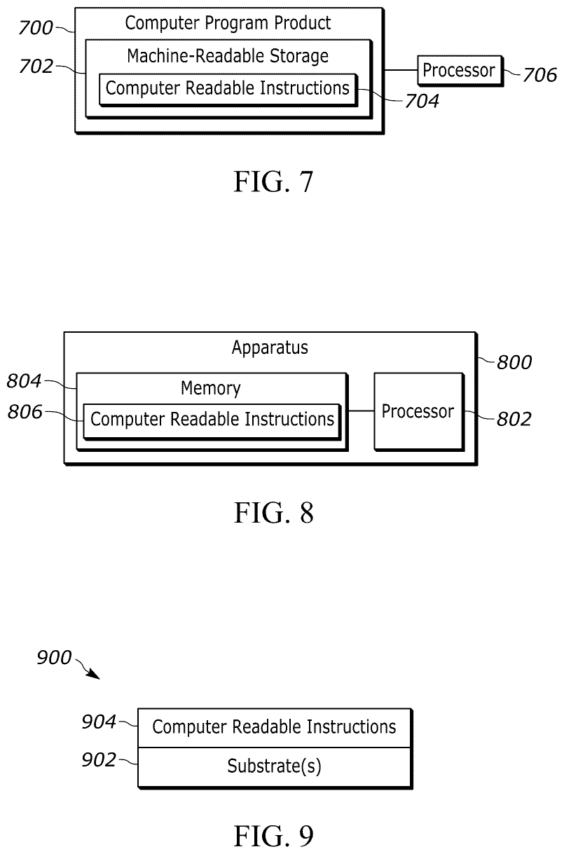

FIG. 7 illustrates a block diagram of an example computer program product 700. In some examples, as shown in FIG. 7, computer program product 700 includes a machine-readable storage 702 that can also include computer readable instructions 704. In some implementations, the machine-readable storage 702 can be implemented as a non-transitory machine-readable storage. In some implementations the computer readable instructions 704, which can be implemented as software, for example. In an example, the computer readable instructions 704, when executed by a processor 706, implement one or more aspects of the method 500 (FIG. 5) and/or method 600 (FIG. 6), already discussed.

FIG. 8 shows an illustrative example of an apparatus 800. In the illustrated example, the apparatus 800 can include a processor 802 and a memory 804 communicatively coupled to the processor 802. The memory 804 can include computer readable instructions 806, which can be implemented as software, for example. In an example, the computer readable instructions 806, when executed by the processor 802, implement one or more aspects of the method 500 (FIG. 5) and/or method 600 (FIG. 6), already discussed.

In some implementations, the processor 802 can include a general purpose controller, a special purpose controller, a storage controller, a storage manager, a memory controller, a micro-controller, a general purpose processor, a special purpose processor, a central processor unit (CPU), the like, and/or combinations thereof.

Further, implementations can include distributed processing, component/object distributed processing, parallel processing, the like, and/or combinations thereof. For example, virtual computer system processing can implement one or more of the methods or functionalities as described herein, and the processor 802 described herein can be used to support such virtual processing.

In some examples, the memory 804 is an example of a computer-readable storage medium. For example, memory 804 can be any memory which is accessible to the processor 802, including, but not limited to RAM memory, registers, and register files, the like, and/or combinations thereof. References to “computer memory” or “memory” should be interpreted as possibly being multiple memories. The memory can for instance be multiple memories within the same computer system. The memory can also be multiple memories distributed amongst multiple computer systems or computing devices.

FIG. 9 shows an illustrative semiconductor apparatus 900 (e.g., chip and/or package). The illustrated apparatus 900 includes one or more substrates 902 (e.g., silicon, sapphire, or gallium arsenide) and computer readable instructions 904 (such as, configurable computer readable instructions (e.g., firmware) and/or fixed-functionality computer readable instructions (e.g., hardware)) coupled to the substrate(s) 902. In an example, the computer readable instructions 904 implement one or more aspects of the method 500 (FIG. 5) and/or method 600 (FIG. 6), already discussed.

In some implementations, computer readable instructions 904 can include transistor array and/or other integrated circuit (IC) components. For example, configurable firmware logic and/or fixed-functionality hardware logic implementations of the computer readable instructions 904 can include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

### ADDITIONAL NOTES AND EXAMPLES

Clause 1 is a magnetic inductive flow sensor, comprising: a housing with an internal passage; a pair of electro-magnets positioned within the housing on opposite sides of the internal passage, the pair of electro-magnets to generate a magnetic field when charged; a pair of electrodes positioned within the housing on opposite sides of the internal passage, the pair of electrodes to detect a voltage representative of a change in the magnetic field as fluid flows through the internal passage; a first temperature sensor positioned within the housing, the first temperature sensor to detect a first value representative of a first temperature of the fluid, wherein the first temperature sensor is composed of a positive temperature coefficient material; and a second temperature sensor positioned within the housing, the second temperature sensor to detect a second value representative of a second temperature of the fluid, wherein the second temperature sensor is composed of a negative temperature coefficient material.

Clause 2 includes the magnetic inductive flow sensor of Clause 1, further comprising a control unit to combine the first value and the second value.

Clause 3 includes the magnetic inductive flow sensor of Clause 1, further comprising a control unit to compare a difference between the first value and the second value against a threshold.

Clause 4 includes the magnetic inductive flow sensor of Clause 3, wherein the control unit is configured to generate an alert when the difference between the first value and the second value exceeds the threshold.

Clause 5 includes the magnetic inductive flow sensor of any one of Clauses 1 to 4, wherein the first temperature sensor is positioned adjacent a first electrode of the pair of electrodes, and wherein the second temperature sensor is positioned adjacent a second electrode of the pair of electrodes.

Clause 6 includes the magnetic inductive flow sensor of any one of Clauses 1 to 4, wherein the first temperature sensor is positioned on a first electrode of the pair of electrodes, and wherein the second temperature sensor is positioned on a second electrode of the pair of electrodes.

Clause 7 includes the magnetic inductive flow sensor of any one of Clauses 1 to 4, wherein the first temperature sensor is positioned in a first electrode of the pair of electrodes, and wherein the second temperature sensor is positioned in a second electrode of the pair of electrodes.

Clause 8 includes the magnetic inductive flow sensor of any one of Clauses 1 to 7, further comprising a third temperature sensor composed of a negative temperature coefficient material.

Clause 9 includes the magnetic inductive flow sensor of Clause 8, further comprising a fourth temperature sensor composed of a positive temperature coefficient material.

Clause 10 includes a method comprising: generating, via a pair of electro-magnets, a magnetic field within an internal passage in a housing; detecting, via a pair of electrodes, a voltage representative of a change in the magnetic field as fluid flows through the internal passage; detecting, via a first temperature sensor, a first value representative of a first temperature of the fluid, wherein the first temperature sensor exhibits a positive temperature coefficient; and detecting, via a second temperature sensor, a second value representative of a second temperature of the fluid, wherein the second temperature sensor exhibits a negative temperature coefficient.

Clause 11 includes the method of Clause 10, further comprising combining the first value and the second value.

Clause 12 includes the method of Clause 10, further comprising comparing a difference between the first value and the second value against a threshold value.

Clause 13 includes the method of Clause 12, further comprising generating an alert when the difference between the first value and the second value exceeds the threshold.

Clause 14 includes the method of Clause 10, further comprising: detecting, via a third temperature sensor composed of a negative temperature coefficient material, a third value representative of a third temperature of the fluid; comparing a difference between the first value and the third value against the threshold value; and generating the alert when the difference between the first value and the third value exceeds the threshold.

Clause 15 includes the method of Clause 10, further comprising: detecting, via a third temperature sensor composed of a negative temperature coefficient material, a third value representative of a third temperature of the fluid; detecting, via a fourth temperature sensor composed of a positive temperature coefficient material, a fourth value representative of a fourth temperature of the fluid; combining the second value, third value, and fourth value into a combined value; comparing a difference between the first value and the combined value against the threshold value; and generating the alert when the difference between the first value and the combined value exceeds the threshold.

Clause 16 includes a system, comprising: a magnetic inductive flow sensor, comprising: a housing with an internal passage; a pair of electro-magnets positioned within the housing on opposite sides of the internal passage, the pair of electro-magnets to generate a magnetic field when charged; a pair of electrodes positioned within the housing on opposite sides of the internal passage, the pair of electrodes to detect a voltage representative of a change in the magnetic field as fluid flows through the internal passage; a first temperature sensor positioned within the housing, the first temperature sensor to detect a first value representative of a first temperature of the fluid, wherein the first temperature sensor is composed of a positive temperature coefficient material; and a second temperature sensor positioned within the housing, the second temperature sensor to detect a second value representative of a second temperature of the fluid, wherein the second temperature sensor is composed of a negative temperature coefficient material; and a secondary sensor coupled to the magnetic inductive flow sensor.

Clause 17 includes the system of Clause 16, wherein the secondary sensor comprises one or more of a pressure sensor, a conductivity sensor, or a fluid level sensor.

Clause 18 includes the system of Clause 16, further comprising a control unit to combine the first value and the second value.

Clause 19 includes the system of Clause 16, further comprising a control unit to compare a difference between the first value and the second value against a threshold.

Clause 20 includes the system of Clause 19, wherein the control unit is configured to generate a service alert when the difference between the first value and the second value exceeds the threshold.

Clause 21 includes a machine-readable storage including machine-readable instructions, which when executed, implement a method or realize an apparatus as claimed in any preceding Clause.

Clause 22 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. A magnetic inductive flow sensor, comprising:
a housing with an internal passage;
a pair of electro-magnets positioned within the housing on opposite sides of the internal passage, the pair of electro-magnets to generate a magnetic field when charged;
a pair of electrodes positioned within the housing on opposite sides of the internal passage, the pair of electrodes to detect a voltage representative of a change in the magnetic field as fluid flows through the internal passage;
a first temperature sensor positioned within the housing, the first temperature sensor to detect a first value representative of a first temperature of the fluid, wherein the first temperature sensor is composed of a positive temperature coefficient material; and
a second temperature sensor positioned within the housing, the second temperature sensor to detect a second value representative of a second temperature of the fluid, wherein the second temperature sensor is composed of a negative temperature coefficient material.

2. The magnetic inductive flow sensor of claim 1, further comprising a control unit to combine the first value and the second value.

3. The magnetic inductive flow sensor of claim 1, further comprising a control unit to compare a difference between the first value and the second value against a threshold.

4. The magnetic inductive flow sensor of claim 3, wherein the control unit is configured to generate an alert when the difference between the first value and the second value exceeds the threshold.

5. The magnetic inductive flow sensor of claim 1, wherein the first temperature sensor is positioned adjacent a first electrode of the pair of electrodes, and wherein the second temperature sensor is positioned adjacent a second electrode of the pair of electrodes.

6. The magnetic inductive flow sensor of claim 1, wherein the first temperature sensor is positioned on a first electrode of the pair of electrodes, and wherein the second temperature sensor is positioned on a second electrode of the pair of electrodes.

7. The magnetic inductive flow sensor of claim 1, wherein the first temperature sensor is positioned in a first electrode of the pair of electrodes, and wherein the second temperature sensor is positioned in a second electrode of the pair of electrodes.

8. The magnetic inductive flow sensor of claim 1, further comprising a third temperature sensor composed of a negative temperature coefficient material.

9. The magnetic inductive flow sensor of claim 8, further comprising a fourth temperature sensor composed of a positive temperature coefficient material.

10. A method comprising:
generating, via a pair of electro-magnets, a magnetic field within an internal passage in a housing;
detecting, via a pair of electrodes, a voltage representative of a change in the magnetic field as fluid flows through the internal passage;
detecting, via a first temperature sensor, a first value representative of a first temperature of the fluid, wherein the first temperature sensor exhibits a positive temperature coefficient; and
detecting, via a second temperature sensor, a second value representative of a second temperature of the fluid, wherein the second temperature sensor exhibits a negative temperature coefficient.

11. The method of claim 10, further comprising combining the first value and the second value.

12. The method of claim 10, further comprising comparing a difference between the first value and the second value against a threshold value.

13. The method of claim 12, further comprising generating an alert when the difference between the first value and the second value exceeds the threshold.

14. The method of claim 12, further comprising:
detecting, via a third temperature sensor composed of a negative temperature coefficient material, a third value representative of a third temperature of the fluid;
comparing a difference between the first value and the third value against the threshold value; and
generating the alert when the difference between the first value and the third value exceeds the threshold.

15. The method of claim 10, further comprising:
detecting, via a third temperature sensor composed of a negative temperature coefficient material, a third value representative of a third temperature of the fluid;
detecting, via a fourth temperature sensor composed of a positive temperature coefficient material, a fourth value representative of a fourth temperature of the fluid;
combining the second value, third value, and fourth value into a combined value;
comparing a difference between the first value and the combined value against the threshold value; and
generating the alert when the difference between the first value and the combined value exceeds the threshold.

16. A system, comprising:
a magnetic inductive flow sensor, comprising:
a housing with an internal passage;
a pair of electro-magnets positioned within the housing on opposite sides of the internal passage, the pair of electro-magnets to generate a magnetic field when charged;
a pair of electrodes positioned within the housing on opposite sides of the internal passage, the pair of electrodes to detect a voltage representative of a change in the magnetic field as fluid flows through the internal passage;
a first temperature sensor positioned within the housing, the first temperature sensor to detect a first value representative of a first temperature of the fluid, wherein the first temperature sensor is composed of a positive temperature coefficient material; and
a second temperature sensor positioned within the housing, the second temperature sensor to detect a second value representative of a second temperature of the fluid, wherein the second temperature sensor is composed of a negative temperature coefficient material; and
a secondary sensor coupled to the magnetic inductive flow sensor.

17. The system of claim 16, wherein the secondary sensor comprises one or more of a pressure sensor, a conductivity sensor, a fluid level sensor, a pH sensor, a dissolved oxygen sensor, a viscosity sensor, a density sensor, or a surface cleanliness sensor.

18. The system of claim 16, further comprising a control unit to combine the first value and the second value.

19. The system of claim 16, further comprising a control unit to compare a difference between the first value and the second value against a threshold.

20. The system of claim 19, wherein the control unit is configured to generate a service alert when the difference between the first value and the second value exceeds the threshold.
